(19) United States
(12) Patent Application Publication
(10) Pub. No.: US 2005/0105918 A1
(43) Pub. Date: May 19, 2005

(54) Generating an optical signal with temporal, spectral and amplitude control

(76) Inventor: Peter A. Ketteridge, Amherst, NH (US)

Correspondence Address: Fogg and Associates, LLC, P.O. Box 581339, Minneapolis, MN, 55458-1339, US

(21) Appl. No.: 10/715,269

(22) Filed: Nov. 14, 2003

(51) Int. Cl. H04B 10/04

(52) U.S. Cl. 398/197; 398/45

(57) ABSTRACT

A system for generating an optical signal is provided. The system includes a plurality of light emitting devices. Each light emitting device has an input and an output. The system also includes a combiner having a plurality of inputs and an output. The plurality of inputs of the combiner are coupled to the outputs of the plurality of light emitting devices. The output of the combiner provides a composite signal. The system also includes a control circuit. The control circuit is coupled to the plurality of light emitting devices. The control circuit controls the plurality of light emitting devices to shape the composite signal in time, frequency, and amplitude.

### BACKGROUND

Optical signals are used in many modem electronic systems. Some spectroscopic systems use optical signals to assist scientists in analyzing chemical reactions and compounds. Other medical systems use optical signals to measure physical phenomenon such as the content of oxygen in the blood. Further, telecommunications systems use optical signals to carry data between user terminals at different locations. Finally, military systems are being designed to use optical signals in such applications as countermeasures, remote sensing for chemical/biological defense, and automatic target recognition.

Some optical systems operate with optical pulses that last for one quadrillionth of a second (10⁻¹⁵ s). Such “femto-second” applications are useful in chemical analysis to track molecular transients of a chemical reaction. One problem introduced in femto-second applications relates to amplifying the pulse signal. Typically, extremely high energy pulses are needed, e.g., on the order of a trillion watts for the duration of the pulse. Unfortunately, a pulse with this much energy could severely damage the equipment even during this short duration. Thus, “chirping” is often used when amplifying these short pulses. With chirping, the optical signal is first spread out in frequency and time with a first grating. Once spread, the signal is amplified and then the components are recombined using a second grating. Since the signal is of a longer duration, the average power is lower and thus, the equipment is not at risk of damage from the amplification. Unfortunately, the equipment used in chirping the optical signal is expensive, complex and requires a significant amount of space.

In other high energy amplification systems, the efficiency of the optical amplifier becomes an issue. It has been discovered that the efficiency of such optical amplifiers can be improved by careful shaping a stepped, seed pulse. However, researchers have not been able to produce a practical technique for generating such a seed signal.

Therefore, what is needed in the art is a technique for generating optical signals with adequate control of temporal, spectral and amplitude characteristics of the optical signal.

### SUMMARY

Embodiments of the present invention provide techniques for generating optical signals with control of temporal, spectral and amplitude characteristics. In one embodiment, advantageously, off-the-shelf components are combined in a novel way to produce an optical signal from a plurality of independent light emitting devices. The outputs of the plurality of light emitting devices are combined to produce an optical signal with the desired temporal, spectral and amplitude characteristics.

In one embodiment, a system for generating an optical signal is provided. The system includes a plurality of light emitting devices. Each light emitting device has an input and an output. The system also includes a combiner having a plurality of inputs and an output. The plurality of inputs of the combiner are coupled to the outputs of the plurality of light emitting devices. The output of the combiner provides a composite signal. The system also includes a control circuit. The control circuit is coupled to the plurality of light emitting devices. The control circuit controls the plurality of light emitting devices to shape the composite signal in time, frequency, and amplitude.

### BRIEF DESCRIPTION OF THE DRAWINGS

FIG. 1 is a block diagram of one embodiment of an optical pulse shape generator using a plurality of light emitting devices to generate an optical signal with selectable temporal, spectral and amplitude characteristics.

FIGS. 2A and 2B are graphs illustrating examples of output of an optical pulse shape generator that uses a plurality of light emitting devices to generate an optical signal with selectable temporal, spectral and amplitude characteristics.

FIGS. 3A and 3B are block diagrams of embodiments of apparatus including an optical pulse shape generator that uses a plurality of light emitting devices to generate an optical signal with selectable temporal, spectral and amplitude characteristics.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

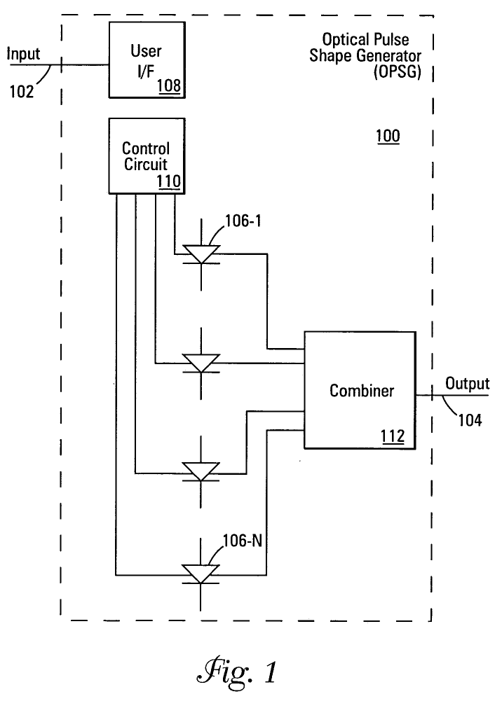

FIG. 1 is a block diagram of an optical pulse shape generator (OPSG), indicated generally at 100, constructed according to one embodiment of the present invention. OPSG 100 includes a plurality of light emitting devices, 106-1 to 106-N, that are selectively turned on and off to generate an optical signal at output 104 based on inputs at input 102. Advantageously, OPSG 100 produces an output signal at output 104 with temporal, spectral and amplitude characteristics selected at input 102. OPSG 100 can be thus be tailored to provide optical signals with appropriate temporal, spectral and amplitude characteristics for specific applications requiring an optical input signal.

OPSG 100 includes user interface (I/F) 108 coupled to input 102. User I/F 108 receives input from a user to define one or more of temporal, spectral and amplitude characteristics of the output signal at output 104 for a specific application. In one embodiment, user I/F 108 comprises one or more of a graphical user interface, a keyboard, a pointing device, a touch screen, or other appropriate existing or later developed interface for gathering input from a user for use by an electronic system.

OPSG 100 includes control circuit 110 for driving the light emitting devices 106-1 to 106-N to produce optical signals used in generating the output signal at output 104. In one embodiment, control circuit 110 comprises one of a general purpose processor, a special purpose processor, a microprocessor, a microcontroller, a programmable logic array, or other existing or later developed circuit appropriate for controlling the operation of the light emitting devices 106-1 to 106-N. Control circuit 110 includes an input that receives the selected characteristics from user interface (I/F) 108. Further, control circuit 110 includes a plurality of outputs. Each output is coupled to a control input of one of the light emitting devices 106-1 to 106-N. Control circuit 110 includes circuitry for generating signals to be applied to the control inputs of the light emitting devices 106-1 to 106-N to drive the respective light emitting devices to produce output optical signals with appropriate temporal, spectral and amplitude characteristics to produce the desired output signal at output 104.

OPSG 100 also includes combiner 112. Combiner 112 is coupled to light emitting devices 106-1 to 106-N. In one embodiment, combiner 112 comprises a single star connector that includes a plurality of inputs and a single output. Each of the plurality of inputs is coupled to one of the light emitting devices 106-1 to 106-N and the output is coupled to output 104 of OPSG 100. In other embodiments, combiner 112 comprises a power combiner. In other embodiments, combiner 112 comprises a plurality of optical couplers, e.g., optical couplers that include two or more inputs and a single output. In this embodiment, the plurality of couplers are connected together to provide an overall configuration with a plurality of inputs and a single output such that the signals from each of the light emitting devices 106-1 to 106-N are combined into a single output signal. The ratio of signal transmission to loss for the components that go into combiner 112 may be used in determining the make-up of a particular combiner 112.

Light emitting devices 106-1 to 106-N each emit light at a selected frequency or spectrum. In one embodiment, OPSG 100 uses off-the-shelf components for the light emitting devices 106-1 to 106-N. For example, in one embodiment, light emitting devices 106-1 to 106-N comprise discrete diodes, e.g., diodes developed for telecommunications applications. In other embodiments, these light emitting devices are embodied in microchip laser diodes, passively q-switched diodes or other appropriate light emitting devices.

In one embodiment, light emitting devices 106-1 to 106-N are independently controlled. Further, in one embodiment, the light emitting devices are connectorized to allow easy connection with combiner 112. Further, any appropriate number of light emitting devices may be included in OPSG 100. Controller 110 selectively turns on and off each of the many diodes to create the optical output signal at output 104 of OPSG 100. In one embodiment, each light emitting device is controlled with 50 picosecond resolution thereby allowing 10 step resolution in a 500 picosecond window.

In operation, OPSG 100 generates an optical signal with desired temporal, spectral and amplitude characteristics using a plurality of light emitting devices. A user selects the desired temporal, spectral and amplitude characteristics for the optical signal based on the specific application. These characteristics are entered into the OPSG 100 at input 102 of user interface 108. These characteristics are fed to control circuit 110. Control circuit 110 uses the characteristics to generate control signals for light emitting devices 106-1 to 106-N. Control circuit 110 applies the control signals to light emitting devices 106-1 to 106-N so that the light emitting devices are turned on at selected times to produce optical pulses with selected frequencies and selected amplitudes. Signal combiner 112 receives the optical signals from the light emitting devices 106-1 to 106-N and constructs an output signal at output 104. The constructed optical signal has the temporal, spectral and amplitude characteristics specified at input 102 of user interface 108.

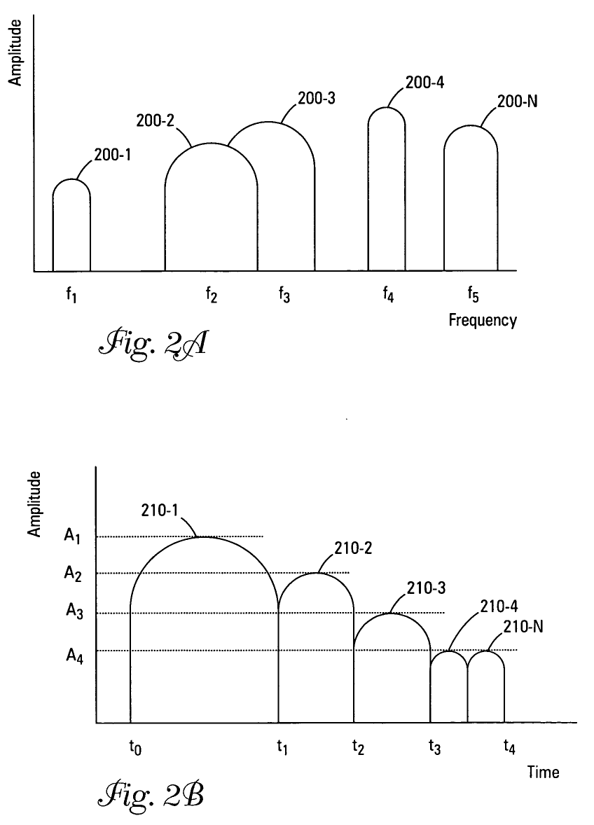

FIGS. 2A and 2B are graphs that illustrate examples of output signals of an optical pulse signal generator, such as at output 104 of OPSG 100 of FIG. 1. These examples are provided by way of explanation and not by way of limitation. It is understood that the specific characteristics of an output signal from the OPSG are defined by the requirements of a particular application, e.g., the desired temporal, spectral and amplitude characteristics of the optical signal needed for the application. Thus, FIGS. 2A and 2B are provided to illustrate how the output signal is generated by combining the outputs of a plurality of light emitting devices thereby providing the ability to generate signals with at least three degrees of freedom, e.g., temporal, spectral and amplitude. In FIG. 2A, the output is shown in the frequency domain. In this example, the output signal includes a plurality of frequency components, e.g., frequency components 200-1 to 200-N. Each of the different frequency components 200-1 to 200-N of the output signal are generated independently by one of the light emitting devices of the OPSG. It is also shown that the amplitude of each frequency components 200-1 to 200-N can be independently controlled.

In FIG. 2B, it is shown that the output of each light emitting device can be controlled independently in time and amplitude. Pulses 210-1 to 210-N are generated sequentially by firing different light emitting devices at selected points in time between t0 and t₄. Advantageously, OPSG 100 of FIG. 1 provides a mechanism for generating optical signals of the shape shown in FIG. 2B because this shape signal is desirable for seeding a power amplifier for more efficient energy use.

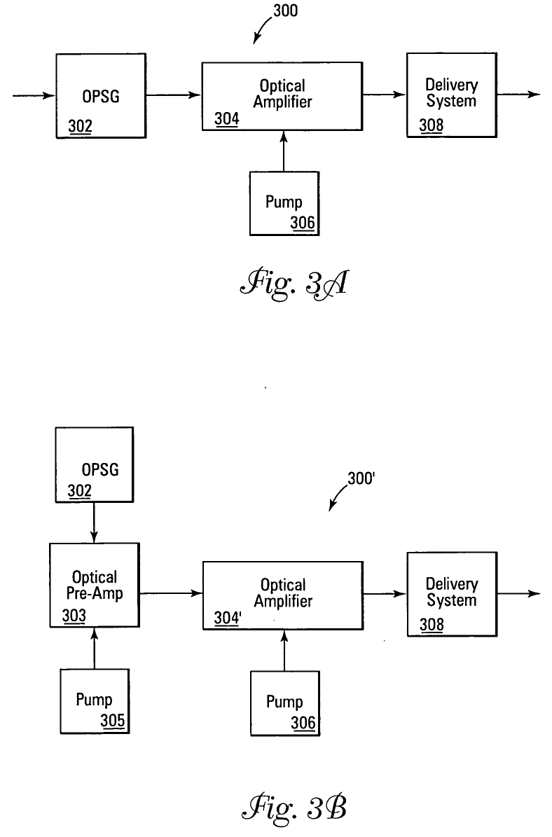

FIG. 3A is a block diagram of one embodiment of a system, indicated generally at 300, including an optical pulse shape generator (OPSG) 302 according to the teachings of the present invention. In one embodiment, OPSG 302 is constructed as discussed above with respect to OPSG 100 of FIG. 1. OPSG 302 generates an optical signal with selected temporal, spectral, and amplitude characteristics using a plurality of light emitting devices. OPSG 302 is coupled to optical amplifier 304. Optical amplifier 304 is coupled to pump system 306 as is known in the art. Optical amplifier 304 comprises any appropriate optical gain medium with proper bandwidth. Further, optical amplifier 304 is coupled to delivery system 308. In one embodiment, delivery system 308 includes an optical fiber. In other embodiments, delivery system 308 includes one or more lenses and other optical signal processing modules to refine the optical signal and/or direct the optical signal at a selected target. In one embodiment, optical amplifier 304 comprises one of a gas laser, a solid state laser, and a fiber laser.

In operation, system 300 delivers an appropriate optical signal based on the output of OPSG 302 to a target via optical amplifier 304 and delivery system 308. OPSG 302 receives inputs to select the temporal, spectral and amplitude characteristics of its output. OPSG 302 provides the output signal to amplifier 304. Amplifier 304 amplifies the signal from OPSG 302 to delivery system 308 for delivery to a target.

System 300 may be used in a number of different environments. For example, system 300 may be tailored for use in military applications ranging from countermeasures, remote sensing for chemical/biological defense, and automatic target recognition. Further, system 300 also finds use in other applications such as spectral analysis, medical applications, optical parametric oscillators, etc.

The embodiment of system 300′ of FIG. 3B differs from the embodiment of system 300 of FIG. 3A by the addition of optical pre-amplifier 303 and its associated pump 305. Further, optical amplifier 304 is replaced with optical power amplifier 304′.

1. A system for generating an optical signal, the system comprising:
a plurality of diodes, each diode having an input and an output;
a combiner having a plurality of inputs and an output, the plurality of inputs coupled to the outputs of the plurality of diodes; and
a control circuit, coupled to the input of each of the plurality of diodes, the control circuit programmable to selectively switch on ones of the plurality of diodes to produce an optical output signal at the output of the combiner with selective control of temporal, spectral and amplitude aspects of the optical signal.

2. The system of claim 1, wherein each diode of the plurality of diodes emits light with a selected frequency.

3. The system of claim 1, wherein each diode of the plurality of diodes is one of a telecommunications diode, a connectorized diode, a microchip laser diode, and a passively q-switched diode.

4. The system of claim 1, wherein the combiner comprises a number of separate combiners coupled together to provide a plurality of inputs and one output.

5. The system of claim 1, wherein the combiner comprises a fiber star connector.

6. A system for generating an optical signal, the system comprising:
a plurality of light emitting devices, each light emitting device having an input and an output;
a combiner having a plurality of inputs and an output, the plurality of inputs coupled to the outputs of the plurality of light emitting devices and the output providing a composite signal; and
a control circuit, coupled to the plurality of light emitting devices, wherein the control circuit controls the plurality of light emitting devices to shape the composite signal in time, frequency, and amplitude.

7. The system of claim 6, and further including a user interface, coupled to the control circuit, the user interface for receiving signals for defining a desired shape for the composite signal.

8. The system of claim 6, wherein each of the light emitting devices comprises one of a telecommunications diode, a connectorized diode, a microchip laser diode, and a passively q-switched diode.

9. The system of claim 6, wherein the combiner comprises a number of separate combiners coupled together to provide a plurality of inputs and one output.

10. The system of claim 6, wherein the combiner comprises a fiber star connector.

11. A method for generating an optical signal, the method comprising:
selecting at least one of amplitude, time and frequency characteristics for the optical signal;
generating a set of control signals to achieve the selected characteristics of the optical signal;
applying the control signals to a plurality of discrete light emitting devices to produce a set of output optical signals with time, frequency and amplitude characteristics based on the selected characteristics for the optical signal;
selectively combining the output optical signals from the discrete light emitting devices to produce the optical signal; and
outputting the optical signal.

12. An apparatus comprising:
an optical pulse shape generator, including:
a plurality of light emitting devices, each light emitting device having an input and an output;
a combiner having a plurality of inputs and an output, the plurality of inputs coupled to the outputs of the plurality of light emitting devices and the output providing a composite signal; and
a control circuit, coupled to the plurality of light emitting devices, wherein the control circuit controls the plurality of light emitting devices to shape the composite signal in time, frequency, and amplitude;
an optical amplifier, coupled to the output of the optical pulse shape generator; and
a delivery system, coupled to the output of the optical amplifier, for delivering the output to a selected target.

13. The apparatus of claim 12, wherein the optical amplifier comprises one of a gas laser, a solid state laser, and a fiber laser.

14. The apparatus of claim 12, wherein the optical amplifier includes an optical pre-amplifier and an optical power amplifier coupled in series with the output of the optical pulse shape generator.

15. The apparatus of claim 12, wherein the delivery system comprises at least one of an optical fiber and at least one fiber optic lens.

16. The apparatus of claim 12, and further including a user interface, coupled to the control circuit, the user interface for receiving signals for defining a desired shape for the composite signal.

17. The apparatus of claim 12, wherein each of the light emitting devices comprises one of a telecommunications diode, a connectorized diode, a microchip laser diode, and a passively q-switched diode.

18. The apparatus of claim 12, wherein the combiner comprises a number of separate combiners coupled together to provide a plurality of inputs and one output.

19. The apparatus of claim 12, wherein the combiner comprises a fiber star connector.

20. A method for generating an optical signal, the method comprising:
selecting at least one of temporal, spectral and amplitude aspects of the optical signal to be generated;
generating control signals for a plurality of light emitting devices to achieve the selected aspects of the optical signal;
applying the control signals to the plurality of light emitting devices; and
optically combining the outputs of the plurality of light emitting devices to produce the optical signal.

21. The method of claim 20, wherein selecting at least one of temporal, spectral and amplitude aspects of the optical signal to be generated comprises selecting temporal, spectral and amplitude values to produce an optical signal that decreases from an initial amplitude in steps to a final amplitude over discrete time intervals during the duration of the optical signal.

22. The method of claim 20, wherein optically combining the output signals comprises combining the outputs of the light emitting devices in a star coupler.

23. The method of claim 20, wherein applying the control signals to the plurality of light emitting devices comprises applying the control signals to a plurality of diodes.

24. A system for generating an optical signal, the system comprising:
a plurality of independent light sources;
means for generating control signals for the plurality of independent light sources to generate the optical signal with selected temporal, spectral and amplitude components; and
means, coupled to the plurality of independent light sources, for optically combining the outputs of the plurality of independent light sources to produce the optical signal.

25. A system for shaping an optical pulse, the system comprising:
a plurality of light emitting diodes, each diode having an input and an output and adapted to produce emit light at a selected frequency;
a combiner having a plurality of inputs and an output, the plurality of inputs selectively coupled to respective ones of the outputs of the plurality of light emitting diodes;
a control circuit, coupled to the input of each of the plurality of light emitting diodes, the control circuit including a drive circuit that is programmable to selectively switch on ones of the plurality of diodes to produce an optical output signal at the output of the combiner with selective control of temporal, spectral and amplitude aspects of the optical signal; and
a user interface, coupled to the control circuit, the user interface for receiving signals for defining a desired shape for the optical signal.
